(19) United States
(12) Patent Application Publication
(10) Pub. No.: US 2017/0155873 A1
(43) Pub. Date: Jun. 1, 2017

(54) SENSOR SYSTEMS AND METHODS

(71) Applicant: Sensors Unlimited, Inc., Princeton, NJ (US)

(72) Inventor: Thuc-Uyen Nguyen, Princeton, NJ (US)

(21) Appl. No.: 14/954,272

(22) Filed: Nov. 30, 2015

(51) Int. Cl. H04N 7/18; H04N 5/225; G01J 3/28

(52) U.S. Cl. CPC H04N 7/18; G01J 3/2823; G01J 3/2803; H04N 5/2254; H04N 5/2253; G01J 2003/2826

(57) ABSTRACT

An imaging system includes a housing having a lens defining a first optical axis. A first sensor is within the housing aligned with the first optical axis. A second sensor is within the housing offset from the first optical axis. A third sensor is within the housing opposite from the second sensor across the first optical axis. A second optical axis is defined between the second and third sensors. A polarized beam splitter is within the housing at an intersection of the first and second optical axes to redirect a portion of incoming photons to the second sensor. A bandpass filter is between the polarized beam splitter and the second sensor to pass a portion of photons traveling from the polarized beam splitter to the second sensor and to reflect a remaining portion of the photons back to the polarized beam splitter.

### BACKGROUND OF THE INVENTION

### 1. Field of the Invention

The present invention relates to sensor systems, and, in particular, to imaging systems.

### 2. Description of Related Art

Traditional imaging systems are used for vision enhancement, e.g. vision enhancement in low light conditions. Imaging systems, such as those in handheld devices, typically have a single sensor configured to generate an image based off of a single spectral band from a single field of view. When it is desired to generate an image from multiple spectral bands, multiple sensors paired with respective apertures, each for one spectral band, are typically used. This can be challenging in applications where compactness is important. In addition, multiple-aperture systems pose imaging and post-processing challenges due to parallax issues.

Such conventional methods and systems have generally been considered satisfactory for their intended purpose. However, there is still a need in the art for systems and methods that allow for improved imaging systems and vision enhancement. The present invention provides a solution for these problems.

### SUMMARY OF THE INVENTION

An imaging system includes a housing having a lens defining a first optical axis. A first sensor is within the housing aligned with the first optical axis. A second sensor is within the housing offset from the first optical axis. A third sensor is within the housing offset from the first optical axis and opposite from the second sensor across the first optical axis. A second optical axis is defined between the second and third sensors. A polarized beam splitter is within the housing at an intersection of the first and second optical axes to redirect a portion of incoming photons traveling from the lens along the first optical axis to the second sensor along the second optical axis. A bandpass filter is between the polarized beam splitter and the second sensor along the second optical axis to pass a portion of photons traveling from the polarized beam splitter to the second sensor along the second optical axis and to reflect a remaining portion of the photons back to the polarized beam splitter toward the third sensor.

In accordance with some embodiments, the polarized beam splitter is angled relative to the first and second optical axes. The polarized beam splitter can include a polarized surface oriented to face the second sensor in order to pass photons reflected back from the second sensor to the third sensor along the second optical axis. The first and second optical axes can be perpendicular to one another. Each of the first, second and third sensors can include respective lenses and focal plane arrays (FPA). Each of the first, second and third sensors can generate respective images using different spectral bands of an overlapping field of view. Each of the first, second and third sensors can be a short-wavelength infrared (SWIR) band sensor, a near infrared (NIR) band sensor, a long-wave infrared (LWIR) band sensor, a medium-wavelength infrared (MWIR) band sensor, and/or a visible band sensor. The imaging system can include a quarter-wave plate between the polarized beam splitter and the bandpass filter along the second optical axis to alter the polarity of photons traveling from the polarized beam splitter to the second sensor along the second optical axis.

In another aspect, a method for directing photons in an imaging system includes receiving photons through a lens in a housing. The lens defines a first optical axis. The method includes passing a first portion of the photons through a beam splitter to a first sensor, reflecting a second portion of the photons along a second optical axis using the beam splitter, and passing a portion of the second portion of the photons through a bandpass filter to a second sensor offset from the first optical axis. The method includes reflecting a remaining portion of the second portion of the photons with the bandpass filter back to the beam splitter and passing the remaining portion of the second portion of the photons through the beam splitter to a third sensor.

It is contemplated that the method can include passing the second portion of the photons through a quarter-wave plate to adjust the polarity of the second portion of the photons. The beam splitter can be a polarized beam splitter. The method can include generating respective images with each of the first, second and third sensors, and can include blending each image together to form a single image. Each of the first, second and third sensors can generate the respective images using different spectral bands of an overlapping field of view.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a top view of a schematic depiction of an exemplary embodiment of an imaging system constructed in accordance with the present disclosure; and

FIG. 2 is a flow chart schematically depicting a method for directing photons in the imaging system of FIG. 1.

### DETAILED DESCRIPTION OF THE PREFERRED EMBODIMENTS

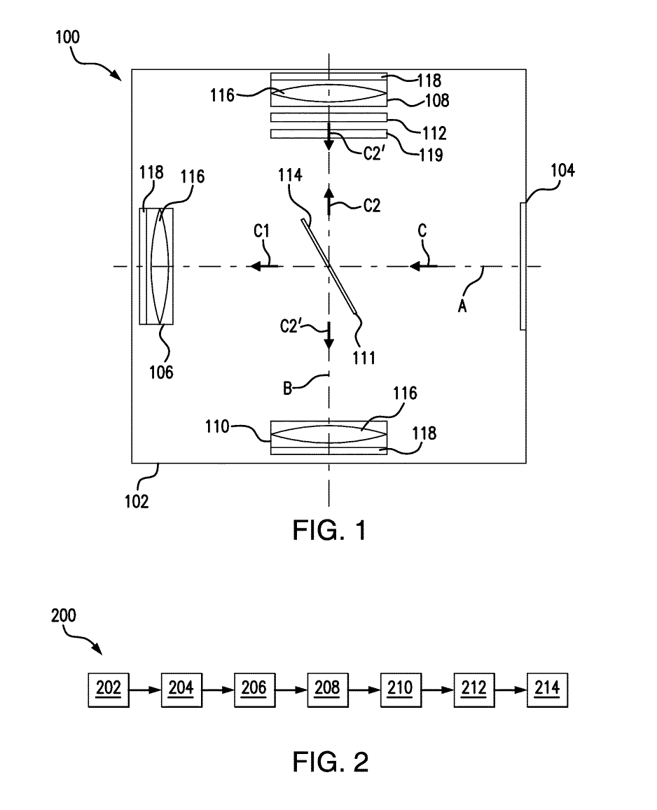

Reference will now be made to the drawings wherein like reference numerals identify similar structural features or aspects of the subject disclosure. For purposes of explanation and illustration, and not limitation, a perspective view of an exemplary embodiment of an imaging system in accordance with the disclosure is shown in FIG. 1 and is designated generally by reference character 100. Other embodiments of imaging systems in accordance with the disclosure, or aspects thereof, are provided in FIG. 2, as will be described.

As shown in FIG. 1, an imaging system 100 includes a housing 102 having a lens 104 defining a first optical axis A. A first sensor 106 within the housing 102 is aligned with first optical axis A. A second sensor 108 within housing 102 is offset from first optical axis A. A third sensor 110 within the housing 102 is offset from first optical axis A and is opposite from the second sensor 108 across first optical axis A. A second optical axis B is defined between the second and third sensors, 108 and 110, respectively. Each of the first, second and third sensors, 106, 108 and 110, respectively, include respective lenses 116 and FPA 118. Each of the first, second and third sensors, 106, 108 and 110, respectively, generate respective images using different spectral bands of an overlapping field of view. It is contemplated that each of the first, second and third sensors, 106, 108 and 110, can be, for example, a short-wavelength infrared (SWIR) band sensor, a near infrared (NIR) band sensor, a long-wavelength infrared (LWIR) band sensor, a medium-wavelength infrared (MWIR) band sensor, and/or a visible band sensor.

With continued reference to FIG. 1, a polarized beam splitter 111 is within housing 102 at an intersection of the first and second optical axes, A and B, respectively. While first and second optical axes, A and B, respectively, are shown perpendicular to one another, those skilled in the art will readily appreciate that the angle between axes A and B vary as needed depending on the orientation of beam splitter 111. Incoming photons traveling from lens 104 along first optical axis A toward beam splitter 111 are indicated schematically by arrow C. Beam splitter 111 passes a first portion of the incoming photons, indicated schematically by arrow C1, through beam splitter 111 along first optical axis to first sensor 106, and redirects a second portion of the incoming photons, indicated schematically by arrow C2, to second sensor 108 along second optical axis B. Polarized beam splitter 111 is angled relative to the first and second optical axes, A and B, respectively.

A bandpass filter 112 is between polarized beam splitter 111 and second sensor 108 along second optical axis B to pass a portion of photons traveling from polarized beam splitter to second sensor 108 along second optical axis B and to reflect a remaining portion of the photons back to polarized beam splitter 111 toward third sensor 110. The remaining portion of the photons is indicated schematically by C2′. System 100 includes a quarter-wave plate 119 between polarized beam splitter 111 and bandpass filter 112 along second optical axis B. Quarter-wave plate 119 alters the polarity of the second portion of photons traveling from polarized beam splitter 111 to second sensor 108, indicated schematically by arrow C2, a portion of those altered photons, represented schematically by C2′, are then reflected back toward third sensor 110 and through quarter-wave plate 119 again, ultimately altering the polarity of the reflected back portion of the second portion of photons a total of one-half. Polarized beam splitter 111 includes a polarized surface 114 oriented to face second sensor 108 in order to pass the remaining photons (e.g. the photons represented schematically by C2′) reflected back from bandpass filter 112 along second optical axis B, to third sensor 110. This results in a multi-sensor imaging system where each sensor accepts the same field of view from the front of beam splitter. This maximizes co-registration among the different channels and reduces processing typically required in traditional systems that have utilize multiple sensors each having different or non-overlapping fields of view.

It is contemplated that in some embodiments, first sensor 106 will detect the least sensitive of the bands being collected as the path to first sensor 106 along axis A, is the most direct and will have the least losses. Second sensor 108, will detect the next least sensitive band and then third sensor 110 will collect the most sensitive band, as third sensor 110 has the least direct path and will likely have the most losses.

As shown in FIG. 2, method 200 for directing photons in an imaging system, e.g. imaging system 100, includes receiving photons through a lens 104, e.g. a lens 104, in a housing 102, e.g. housing 102, as indicated by box 202. Method 200 includes passing a first portion of the photons through a beam splitter, e.g. polarized beam splitter 111, along a first optical axis, e.g. optical axis A, to a first sensor, e.g. first sensor 106, and reflecting a second portion of the photons along a second optical axis, e.g. second optical axis B, using the beam splitter, as indicated by box 204. Method 200 includes passing the second portion of the photons through a quarter-wave plate, e.g. quarter-wave plate 119, to adjust the polarity of the second portion of the photons, as indicated by box 206.

Method 200 includes passing a portion of the second portion of the photons through a bandpass filter, e.g. bandpass filter 112, to a second sensor, e.g. second sensor 108, as indicated by box 208. Method 200 includes reflecting a remaining portion of the second portion of photons with the bandpass filter back through the quarter-wave plate to further adjust the polarity of the remaining portion of the second portion of photons and back to the beam splitter, as indicated by box 210. Method 200 includes passing the remaining portion of the second portion of the photons through the beam splitter to a third sensor, e.g. third sensor 110, as indicated by box 212.

Method 200 includes generating respective images with each of the first, second and third sensors and includes blending at least two images together to form a single image, as indicated by box 214. Each of the first, second and third sensors generate their respective images using different spectral bands of an overlapping field of view. It is contemplated that the image or images formed can be used in a monitoring system, e.g. a security monitoring system, optical instruments, e.g. handheld devices, or optionally be displayed on a display, e.g. a display found in a vehicle, or in any other suitable application. The methods and systems of the present disclosure, as described above and shown in the drawings, provide for imaging systems with superior properties including improved uniformity, reduced processing, and compact size. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. An imaging system comprising:
a housing having a lens defining a first optical axis;
a first sensor within the housing aligned with the first optical axis;
a second sensor within the housing offset from the first optical axis;
a third sensor within the housing offset from the first optical axis opposite from the second sensor across the first optical axis, wherein a second optical axis is defined between the second and third sensors;
a polarized beam splitter within the housing at an intersection of the first and second optical axes to redirect a portion of incoming photons traveling from the lens along the first optical axis to the second sensor along the second optical axis; and
a bandpass filter between the polarized beam splitter and the second sensor along the second optical axis to pass a portion of photons traveling from the polarized beam splitter to the second sensor along the second optical axis and to reflect a remaining portion of the photons back to the polarized beam splitter toward the third sensor.

2. The imaging system as recited in claim 1, wherein the polarized beam splitter is angled relative to the first and second optical axes.

3. The imaging system as recited in claim 1, wherein the polarized beam splitter includes a polarized surface oriented to face the second sensor in order to pass photons reflected back from the second sensor to the third sensor along the second optical axis.

4. The imaging system as recited in claim 1, further comprising a quarter-wave plate between the polarized beam splitter and the bandpass filter along the second optical axis to alter the polarity of photons traveling from the polarized beam splitter to the second sensor along the second optical axis.

5. The imaging system as recited in claim 1, wherein each of the first, second and third sensors include respective lenses and focal plane arrays (FPA).

6. The imaging system as recited in claim 1, wherein each of the first, second and third sensors generate respective images using different spectral bands of an overlapping field of view.

7. The imaging system as recited in claim 1, wherein the first and second optical axes are perpendicular to one another.

8. The imaging system as recited in claim 1, wherein each of the first, second and third sensors are at least one of a SWIR band sensor, a NIR band sensor, a LWIR band sensor, a MWIR band sensor, or a visible band sensor.

9. A method for directing photons in an imaging system comprising:
receiving photons through a lens in a housing, wherein the lens defines a first optical axis;
passing a first portion of the photons through a beam splitter to a first sensor;
reflecting a second portion of the photons along a second optical axis using the beam splitter;
passing a portion of the second portion of the photons through a bandpass filter to a second sensor offset from the first optical axis;
reflecting a remaining portion of the second portion of the photons with the bandpass filter back to the beam splitter; and
passing the remaining portion of the second portion of the photons through the beam splitter to a third sensor.

10. The method as recited in claim 9, further comprising passing the second portion of the photons through a quarter-wave plate to adjust the polarity of the second portion of the photons.

11. The method as recited in claim 9, wherein the beam splitter is a polarized beam splitter.

12. The method as recited in claim 9, further comprising generating respective images with each of the first, second and third sensors.

13. The method as recited in claim 12, further comprising blending each image together to form a single image.

14. The method as recited in claim 12, wherein each of the first, second and third sensors generate the respective images using different spectral bands of an overlapping field of view.

15. The method as recited in claim 9, wherein each of the first, second and third sensors are at least one of a SWIR band sensor, a NIR band sensor, a LWIR band sensor, a MWIR band sensor, or a visible band sensor.
